(19) United States
(12) Patent Application Publication
(10) Pub. No.: US 2007/0115612 A1
(43) Pub. Date: May 24, 2007

(54) Aluminium electrolytic capacitor

(76) Inventors: Koichiro Minato, Kyoto (JP); Hiroshi Kurimoto, Yamaguchi (JP); Tsuyoshi Yoshino, Kyoto (JP); Yoshihiro Watanabe, Osaka (JP)

Correspondence Address: PATENTTM.US, P. O. BOX 82788, PORTLAND, OR, 97282-0788, US

(21) Appl. No.: 10/566,324

(22) PCT Filed: Jul. 28, 2004
(86) PCT No.: PCT/JP04/10739

§ 371 Date: Jan. 26, 2006

(30) Foreign Application Priority Data
Jul. 29, 2003 (JP) 2003-281605

(51) Int. Cl. H01G 9/08; H01G 2/10

(52) U.S. Cl. 361/517

(57) ABSTRACT

For realizing an electronic part of high reliability excelling in sealer airtightness and mountability, from which the evaporation of driving electrolyte is less, there is provided an aluminum electrolytic capacitor comprising bottomed cylindrical metal case (12) accommodating capacitor element (11) impregnated with a driving electrolyte and elastic sealer (13) closing the opening of the metal case (12), wherein the sealer (13) is composed mainly of an ethylene-propylene-diene terpolymer rubber (EPDM) of 30 to 70 wt.% ethylene content and has a glass transition temperature ranging from −70 to −30° C.

### FIELD OF INVENTION

The present invention relates to an aluminum electrolytic capacitor in which an open Portion of a metal case for accommodating capacitance element impregnated with driving electrolyte is sealed with an elastic sealing member to provide high reliability with improved airtight performance.

### BACKGROUND ART

FIG. 1 is a cross section view of a conventional aluminum electrolytic capacitor. In FIG. 1, 11 is a capacitance element, 12 is a metal case for accommodating the capacitance element 11 together with driving electrolyte (not shown), 13 is an elastic sealing member for sealing the open portion of the metal case 12, 14 and 15 are an anode lead wire and a cathode lead wire from the above mentioned capacitance element 11, respectively.

In the conventional aluminum electrolytic capacitor of the construction as described hereinabove, ethylene glycol was often used as the primary solvent with an additive of ammonium salt of organic acid as the driving electrolyte which is impregnated with the above mentioned capacitance element 11. Also, it was most typical that the sealing member 13 composed of styrene-butadiene rubber (SBR) or ethylene propylene rubber (EPM).

Moreover, in recent years, there are increasing needs for high reliability over wider temperature range. This makes it necessary to use γ-butyrolactone instead of ethylene glycol as the solvent of the above mentioned driving electrolyte. As a result, since electrical conductivity of the driving electrolyte using ammonium salt of organic acid which is used as the conventional electrolytic component is low, it becomes generally popular to use quaternary ammonium salt of organic acid

Also, the replacement of such driving electrolyte accompanied the use of isobutylene-isoprene rubber, i.e., so-called butyl rubber (IIR) with improved airtight performance as the above mentioned sealing member 13.

For example, Patent documents 1 and 2 are known as prior art technical document information relating to the present invention.

[Patent document 1] JP-A-2000-173876

[Patent Document 2] JP-A-2000-173877

### DISCLOSURE OF INVENTION

Problems to be Solved by the Invention

However, in the conventional aluminum electrolytic capacitor as described hereinabove, if a life test is conducted under high temperature or high temperature and high humidity on an aluminum electrolytic capacitor made of a combination of the sealing member 13 made from butyl rubber (IIR) which is excellent in airtight performance and the driving electrolyte comprising quaternary ammonium salt of organic acid as the electrolyte, there encounters a problem that the above mentioned driving electrolyte causes an adverse effect on the sealing member 13 because the driving electrolyte which is accommodated in the metal case 12 together with the capacitance element 11 tends to evaporate and dissipate.

Although it is possible to provide an aluminum electrolytic capacitor with low impedance and long lifetime by a combination of a particular driving electrolyte and a particular sealing member, there is a problem over the wide temperature range, particularly at low temperature (below the freezing point) in which airtight performance of the sealing member degrades.

It is therefore an object of the present invention to overcome the above problems of the conventional capacitors and to provide an aluminum electrolytic capacitor without degrading airtight performance of the sealing member at a temperature below the freezing point and maintaining excellent reliability.

Means to Solve the Problems

In order to solve the above problem the present invention is an aluminum electrolytic capacitor comprising a bottomed cylindrical metal case for accommodating a capacitance element with impregnated driving electrolyte and an elastic sealing member for sealing the open portion of the metal case, wherein the sealing member is made from ethylene-propylene-diene three way copolymer rubber EPDM) containing 30-70 wt % of ethylene as a primary material and the glass transition temperature of the sealing member is in the range between −70° C. and −30° C. The sealing member made from the above mentioned ethylene-propylene-diene three way copolymer rubber (EPDM) as a primary material is excellent in heat resistance and chemical resistance and maintains elastic characteristic at a low temperature (below the freezing point). By choosing the ethylene content to 30-70 wt %, it is possible to make the glass transition temperature in the range between −70° C. and −30° C., thereby specially exhibiting the function to improve airtight performance of the aluminum electrolytic capacitor at a low temperature below the freezing point.

It is to be noted herein that the sealing member cannot maintain the characteristic of the synthetic rubber if the ethylene content of the ethylene-propylene-diene three way copolymer rubber (EPDM) is chosen to be less than 30 wt % (i.e., increasing the propylene content), while providing an improved workability but tending to be easily crystallized and thus failing to improve airtight Performance at a low temperature if the ethylene content is in excess of 70 wt %. Accordingly, it is preferable that the ethylene content is in the range between 40-60 wt %.

Moreover, if the glass transition temperature of the sealing member is lower than −70° C., the sealing member is inferior in heat resistance and weather resistance and exhibiting Poor workability. On the other hand, if the glass transition temperature is in excess of −30° C., the sealing member becomes poor in elasticity and airtight performance at a low temperature.

Here, the glass transition temperature means the measurements by the differential scanning calorimeter (DSC) based on the JIS (Japan Industrial Standard) (K7121) and followed its calculation method of the glass transition temperature (Teg).

The diene in the ethylene-propylene-diene three way copolymer rubber (EPDM) comprises at least one material of 5-ethylidene-2-norbornene (ENB), di-cyclopentadiene (DCPD) and 1, 4-hexadiene (HD) and the amount is in the range between 3-6 wt %. The above mentioned 5-ethylidene-2-norbornene acts to enhance reaction speed and bridging speed of the ethylene-propylene copolymerization and the amount is preferably in the range between 3-6 wt %.

It is to be noted that reaction speed and bridging speed of the ethylene-propylene copolymerization are low if the amount of diene is less than 3wt %, while enhancing unsaturated linkage and thus resulting in decrease in heat resistance and weather resistance if the amount of diene is in excess of 6 wt %

The ethylene-propylene-diene three way copolymer rubber (EPDM) is bridged with peroxide, thereby excluding any strong oxidizing sulfur component in the sealing member and avoiding corrosion of lead wires and deterioration of the sealing member itself.

Moreover, at least one material as the driving electrolyte is selected from ethylene glycol, γ-butyrolactone, propylene carbonate, sulfolane and water, and at least one electrolytic salt selected from the group of organic acid, inorganic acid, ammonium salt of organic acid or inorganic acid, or primary-quaternary ammonium salt, imidazoleiumsalt, imidazoliniumand derivative thereof. This enables to eliminate any adverse effect in combining with the sealing member, thereby realizing the aluminum electrolytic capacitor with suppressed reduction in airtight performance of the sealing member and with excellent reliability in a life test at high temperature or a life test under high temperature and high humidity condition.

Advantages of the Invention

According to the present invention as described hereinabove, the aluminum electrolytic capacitor comprises a bottomed cylindrical metal case for accommodating a capacitance element with impregnated driving electrolyte and the elastic sealing member for sealing the open portion of the metal case, wherein the sealing member is made from ethylene-propylene-diene three way copolymer rubber (EPDND containing 30-70 wt % of ethylene as a primary material and glass transition temperature of the sealing member is in the range between −70° C. and −30°C., thereby making the sealing member made from ethylene-propylene-diene three way copolymer rubber (EPDM) as a primary material excellent in heat resistance and chemical resistance and maintaining elasticity of the sealing member at a low temperature (below the freezing point). By choosing the amount of ethylene in the range between 30-70 wt %, the glass transition temperature of the sealing member can be in the range between −70°C. and −30C., thereby improving airtight performance of the aluminum electrolytic capacitor at a low temperature, in particular below the freezing point. Therefore, the aluminum electrolytic capacitor is useful for various types of electronics.

### BRIEF DESCRIPTION OF THE DRAWING

FIG. 1 is a cross section view of the aluminum electrolytic capacitor according to the present invention and prior art

### DESCRIPTION OF NOTATIONS

11 capacitance element
12 metal case
13 sealing member
14 anode lead wire
15 cathode lead wire

### BEST MODE OF PERFORMING THE INVENTION

Now, embodiments of the present invention will be described below.

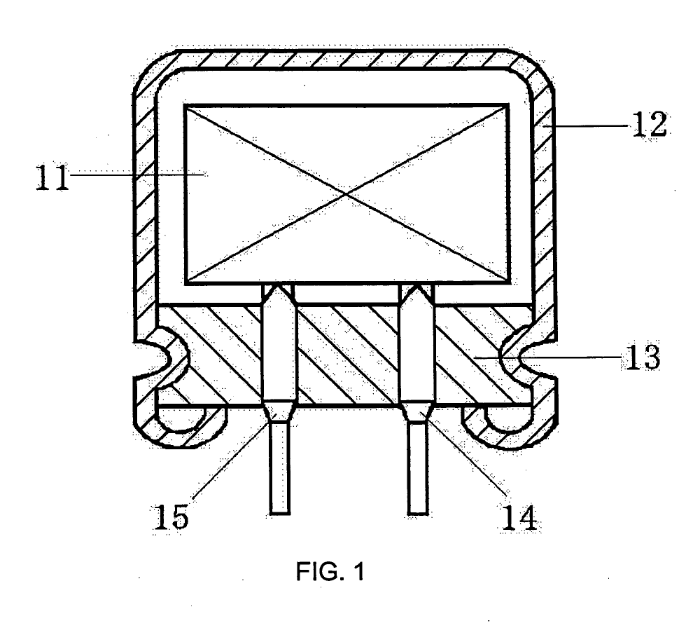

The construction of the aluminum electrolytic capacitor according to the embodiment of the present invention is the same as FIG. 1 which shows the conventional aluminum electrolytic capacitor. That is, in FIG. 1, 11 is a capacitance element which comprises an anode foil of an aluminum foil with a roughed surface and formed with an oxidation film by electrolytic anodizing and a cathode foil laminated with a separator between the anode foil and the cathode foil before being wound.

12 is a metal case for accommodating the capacitance element 11 together with driving electrolyte (not shown). 13 is an elastic sealing member for sealing the open portion of the metal case 12. 14 and 15 are an anode lead wire and a cathode lead wire for respectively leading out of the above mentioned capacitance element 11. The sealing member 13 is formed with openings through which the anode lead wire 14 and the cathode lead wire 15 extend. By piercing the both lead wires 14, 15 into the openings, the sealing member 12 is first inserted into the open portion of the metal case 12, and then the open end of the metal case 12 is bent inwardly to press onto the sealing member 13. Furthermore, the circumference of the metal case 12 is crimped toward the sealing member 13 for sealing by holding it in position due to elasticity of the sealing member 13.

The above mentioned sealing member 13 is made from ethylene-propylene-diene three way copolymer rubber (EPDM) as a primary material and additives such as vulcanizing agent, vulcanizing assisting agent, reinforcing agent,. bulking agent, antioxidant and the like are kneaded and then molded to form the sealing member 13.

There is no problem to use butyl rubber (IIR), urethane rubber (U), silicone rubber (Q) or chlorosulfuric polyethylene rubber (CSM) together with the ethylene-propylene-diene three way copolymer rubber (EPDM) to an amount not to spoil the property of the EPDM.

In the above mentioned ethylene-propylene-diene three way copolymer rubber (EPDM), the ethylene content must be in the range between 30 and 70 wt % By restricting the ethylene content, it is possible to improve elastic Property specially at a low temperature among many properties which are peculiar to the ethylene-propylene-diene three way copolymer rubber (EPDM), thereby holding the glass transition temperature of the sealing member in the range between −70° C. and −30° C. Asaresult, airtight property of the aluminumelectrolytic capacitor can be improved at a low temperature below the freezing point.

In the above mentioned ethylene-propylene-diene three way copolymer rubber (EPDM), the diene component may be 5-ethylidene-2-noruborunane (ENB), di-cyclopentadiene (DCPD), 1, 4-hexadiene (HD) or the like, however, 5-ethylidene-2-norbornane (ENB) is preferable in terms of enhancing reactivity and bridging speed of polymerization with ethylene-propylene.

As the above mentioned vulcanizing agent, sulfur compositions or organic peroxide vulcanizing agents can be used. However, since the use of sulfur compositions tends to deteriorate the anode lead wire and the cathode lead wire extending through the sealing member, it is preferable to use organic peroxides. Preferable examples as the organic peroxide vulcanizing agent include dicumyl peroxide, 2, 5-dimetyl-2, 5-di (t-butyl peroxy) hexane, 2, 5-dimethyl-2, 5-di (benzoyl peroxy) hexane, 2, 5-dimetyl-2, 5-di (t-butyl peroxy) hexyne-3, di-t-butyl peroxide, di-t-butyl peroxy-3, 3, 5-trimethylcyclohexane, di-t-butyl hydroperoxide and the like. Among these materials, dicumyl peroxide, di-t-butyl peroxide and di-t-butyl peroxy-3, 3, 5-trimethyl cyclohexane are preferable. These organic peroxides are normally added in the amount of 0.1-10 wt %, preferably 2-5 wt % with respect to 100 wt % of ethylene-propylene-diene three way copolymer rubber (EPDM).

Examples of the vulcanizing assisting agent include quinone dioxime system such as p-quinone dioxime, (meta) acrylic compounds such as ethylene glycol dimethacrylate, trimethylolpropane trimethacrylate and the like, allylic compounds such as diallyl phthalate, triallyl isocyannate and the like, other maleimide compounds, divinylbenzene, etc. Such vulcanizing assisting agent is added to the organic peroxide to be used in the range of 0.5-2 mole with respect to 1 mole of the organic peroxide, preferably an equal mole ratio.

A suitable reinforcing agent is, for example, various types of carbon black such as SRF, GPF, FEF, MAF, ISAF, SAF, FT, MTor the like, pulverinized silicic acid, etc. For example, light calcium carbonate, heavy calcium carbonate, talc, clay or the like is used as a bulking agent. Such reinforcing agent and bulking agent are normally compounded normally 200 wt % or less, preferably 150 wt % or less with respect to 100 wt % of ethylene-propylene-diene three way copolymer rubber (EPDM).

The present invention demonstrates excellent heat resistance and weather resistance without using antioxidant. However, if antioxidant is used, it is possible to extend the lifetime of the seal member. Examples of the antioxidant include aromatic secondary amine stabilizers such as phenylbutylamine and N, N′-di-2-naphthyl-p-phenylene diamine, phenol system stabilizer such as dibutylhydroxytoluene, tetrakis [methylene-3(3, 5-di-t-butyl-4-hydroxyphenyl) cinnamate] methane and the like, thioether stabilizer such as bis [2-methyl-4-(3-n-alkylthiopropionyloxy)-5-t-butylphenyl] sulfide and the like, dithiocarbamate system stabilizer such as nickel dibutyl diocarbamide, etc. Such antioxidants may be used solely or in a mixture of two or more materials in the range of normally 0.1-5 wt %, preferably 0.5-3 wt % with respect to 100 wt % of the ethylene-propylene-diene three way copolymer rubber (EPDM).

It is also possible to add a processing aid if necessary. Such processing aid may be any processing aid which is normally used in processing rubber. Examples of such processing aid include higher fatty acids such asricinolic acid, stearic acid, palmitic acid, lauric acid and the like, higher fatty acid salt such as barium stearate, calcium stearate, zinc stearate and the like, higher fatty acid ester such as ricinoleate, stearate, palmitate, laurate and the like, etc. Such processing aid is normally added in the range of 10 wt % or less, preferably 1-5 wt % with respect to 100 wt % of the ethylene-propylene-diene three way copolymer rubber (EPDM).

Used as the above mentioned driving electrolyte is one or more solution selected from ethylene glycol, γ-butyrolactone, propylene carbonate, sulfolane and water. It is possible to use by adding to the above material one or more electrolytic salt selected from organic acid, inorganic acid, ammonium salt of organic acid or inorganic acid, or primary-quaternary ammonium salt, imidazolium salt, imidazolinium and the derivative thereof.

The above mentioned organic acid or inorganic acid may be organic acids such as formic acid, acetic acid, propionic acid, maleic acid, citraconic acid, phthalic acid, adipic acid, azelaic acid, benzoic acid, butyl octanoic acid, decanedicarboxylic acid and the like or inorganic acids such as boric acid, phosphoric acid and the like. It is also possible to use primary-quaternary ammonium salt of these materials.

Also, examples of the above mentioned imidazolium salt, imidazolinium and their derivatives include quaternary imidazolin compounds substituted by alkyl group or arylalkyl group of one carbon through 11 carbons, imidazole compounds, benzoimidazole compounds and alicyclic pyrimidine compounds. Concretely, it is possible to provide a high electrical conductivity and low loss aluminum electrolytic capacitor by using Preferably materials such as 1-methyl-1, 8-diazabicyclo [5, 4, 0] undecane-7, 1-methyl-i, 5-diazabicyclo [4, 3, 0] nonane-5, 1, 2, 3-trimethyl imidazolinium, 1, 2, 3, 4-tetramethyl imidazolinium, 1, 3-dimethyl-2-ethyl-imidazolinim, 1, 3, 4-trimethyl-2-ethyl imidazoliniuw, 1, 3-dimethyl-2-heptyl imidazolinium 1, 3-dimethyl-2-(-3′ heptyl) imidazolinium 1, 3-dimetyl-2-dodecyl imidazoliumr 1,2, 3-trimethyl-1, 4, 5, 6-tetrahydropyrimidium, 1, 3-dimethyl imidazolium and 1, 3-dimethyl benzoimidazolinium.

Now, the present invention will be described in greater detail by way of embodiments. It is to be noted that composition of the seal member to be used in the embodiments is shown in Table 1 and the composition of the driving electrolyte is shown in Table 2.

TABLE 1

| Composition of sealing member (wt %) | | A | B | C | D | E | F | G | H |
|---|---|---|---|---|---|---|---|---|---|
| synthetic | EPDM | 100 | 100 | 100 | 100 | 100 | 100 | 100 | 100 |
| rubber | (amount of ethylene) | (30) | (40) | (50) | (60) | (70) | (50) | (50) | (50) |
| component | (5-etylidene-2-norbornene) | (5) | | (5) | | (5) | (3) | (3) | (6) |
| | (diecyclopentadiene) | | (5) | | | | | | |
| | (1,4-hexadiene) | | | | (5) | | | | |
| valcanyzing | dicumyl peroxide | 5.0 | 5.0 | 5.0 | 5.0 | 5.0 | | 2.5 | 5.0 |
| agent | di-t-butylperoxide | | | | | | 5.0 | 2.5 | |
| valcanyzing | p-quinone dioxime | 0.5 | 0.5 | 0.5 | 0.5 | 0.5 | 0.5 | 0.5 | 0.5 |
| assisting agent | | | | | | | | | |
| reinforcing | carbon black (SRF) | 30 | 30 | 30 | 30 | 30 | 50 | 50 | 20 |
| agent | calcium carbonate (heavy) | 100 | 100 | 100 | 100 | 100 | | 20 | 40 |
| and bulking | clay | | | | | | 120 | 80 | 40 |
| agent | | | | | | | | | |
| antioxidant | phenyl-butylamine | 0.5 | 0.5 | 0.5 | 0.5 | 0.5 | 0.5 | 0.5 | 0.5 |
| processing aid | stearic acid | 0.5 | 0.5 | 0.5 | 0.5 | 0.5 | 0.5 | 0.5 | 0.5 |

| | | | | | | | | |
|---|---|---|---|---|---|---|---|---|
| glass transition temperature (° C.) | −69 | −57 | −43 | −36 | −31 | −35 | −32 | −46 |

TABLE 2

| Composition of driving | | | | | | | | |
|---|---|---|---|---|---|---|---|---|
| electrolyte(wt %) | A | B | C | D | E | F | G | H |
| ethylene glycol | 85 | 86 | 85 | 30 | | | | 30 |
| γ-butyrolactone | | | | 45 | 82 | 45 | 45 | |
| sulfolane | | | | | | 35 | 35 | |
| ammonium borate | | 1 | | | 1 | 1 | | 1 |
| phosphoric acid | 1 | | 2 | | | | | |
| ammonium azelate | 13 | 8 | | | 5 | 8 | 3 | 5 |
| 1,6-decanedicalboxylate | | 5 | 12 | 2 | 2 | | | 4 |
| p-nitro benzoate | 0.5 | | 1 | | | 11 | 5 | |
| 1,3-dimetyl-2-ethyl- | | | | 23 | 10 | | 12 | |
| imidazolinium | | | | | | | | |
| water | 0.5 | | | | | | | 60 |

### Embodiment 1

Electrolyte A is impregnated with a wound type capacitance element which comprises an anode foil and a cathode foil laminated with Manila fiber between them and wound by themselves before being placed in a bottomed aluminum metal case together with a sealing member A. An aluminum electrolytic capacitor with 35V in the rated voltage and 2200 μF in capacitance is completed by sealing the opening portion of the metal case by a curling treatment.

### Embodiment 2

An aluminum electrolytic capacitor which is the same as the above Embodiment 1 except the use of a sealing member B as the sealing member is made.

### Embodiment 3

An aluminum electrolytic capacitor which is the same as the above Embodiment 1 except the use of a sealing member C as the sealing member is made.

### Embodiment 4

An aluminum electrolytic capacitor which is the same as the above Embodiment 1 except the use of a sealing member D as the sealing member is made.

### Embodiment 5

An aluminum electrolytic capacitor which is the same as the above Embodiment 1 except the use of a sealing member E as the sealing member is made.

### Embodiment 6

An aluminum electrolytic capacitor which is the same as the above Embodiment 1 except the use of a sealing member F as the sealing member is made.

### Embodiment 7

An aluminum electrolytic capacitor which is the same as the above Embodiment 1 except the use of a sealing member G as the sealing member is made.

### Embodiment 8

An aluminum electrolytic capacitor which is the same as the above Embodiment 1 except the use of a sealing member H as the sealing member is made.

### Embodiment 9

An aluminum electrolytic capacitor which is the same as the above Embodiment 1 except the use of an electrolyte B as the electrolyte is made.

### Embodiment 10

An aluminum electrolytic capacitor which is the same as the above Embodiment 1 except the use of an electrolyte C as the electrolyte is made. [0047

### Embodiment 11

An aluminum electrolytic capacitor which is the same as the above Embodiment 1 except the use of an electrolyte D as the electrolyte is made.

### Embodiment 12

An aluminum electrolytic capacitor which is the same as the above Embodiment 1 except the use of an electrolyte E as the electrolyte is made.

### Embodiment 13

An aluminum electrolytic capacitor which is the same as the above Embodiment 1 except the use of an electrolyte F as the electrolyte is made.

### Embodiment 14

An aluminum electrolytic capacitor which is the same as the above Embodiment 1 except the use of an electrolyte G as the electrolyte is made.

### Embodiment 15

An aluminum electrolytic capacitor which is the same as the above Embodiment 1 except the use of an electrolyte H as the electrolyte is made.

### REFERENCE EXAMPLE 1

An aluminum electrolytic capacitor which is the same as the above Embodiment 1 except the use of a sealing member of the following composition is made.

| | | |
|---|---|---|
| synthetic rubber | butane rubber (IIR) | 100 wt % |
| vulcanizing agent | zinc oxide | 3 wt % |
| reinforcing agent | carbon black | 50 wt % |
| | calcium carbonate | 50 wt % |
| antioxitant | phenylbutylamine | 0.5 wt % |
| processing aid | stearic acid | 0.5 wt % |
| glass transition temperature | −48° C. | |

### REFERENCE EXAMPLE 2

An aluminum electrolytic capacitor which is the same as the above Reference Example 1 except the use of styrene-butadiene rubber (SBR) as the synthetic rubber is made. The glass transition temperature of the sealing member was −15° C.

### REFERENCE EXAMPLE 3

An aluminum electrolytic capacitor which is the same as the above Reference Example 1 except the use of an ethylene-propylene rubber (EPND as the synthetic rubber is made. The glass transition temperature of the sealing member was −10°C.

In order to confirm airtight Performance of the sealing members in the above Embodiments 1-15 and the Reference Examples 1-3, airtight measurement results at high temperature (105° C.) and high humidity (at test temperature 85° C. and 85% in relative humidity) are shown (see Table 3). Airtight measurement results at test temperature −40° C. are also shown (see Table 4).

[Table 3]

High Temperature Test: sealing performance measurement results of sealing member at test temperature of 105° C.
High Temperature High Humidity Test: sealing performance measurement results of sealing member at test temperature of 85° C. and relative humidity of 85%

Note in the table that the denominator is the number of test samples and the numerator is the number of test samples to have had airtight trouble.

| | | | | High Temperature | | |
|---|---|---|---|---|---|---|
| | High Temperature Test | | | High Humidity Test | | |
| | 1000 hrs | 3000 hrs | 5000 hrs | 1000 hrs | 3000 hrs | 5000 hrs |
| Embodiment 1 | 0/20 | 0/20 | 0/20 | 0/20 | 0/20 | 0/20 |
| Embodiment 2 | 0/20 | 0/20 | 0/20 | 0/20 | 0/20 | 0/20 |
| Embodiment 3 | 0/20 | 0/20 | 0/20 | 0/20 | 0/20 | 0/20 |
| Embodiment 4 | 0/20 | 0/20 | 0/20 | 0/20 | 0/20 | 0/20 |
| Embodiment 5 | 0/20 | 0/20 | 0/20 | 0/20 | 0/20 | 0/20 |
| Embodiment 6 | 0/20 | 0/20 | 0/20 | 0/20 | 0/20 | 0/20 |
| Embodiment 7 | 0/20 | 0/20 | 0/20 | 0/20 | 0/20 | 0/20 |
| Embodiment 8 | 0/20 | 0/20 | 0/20 | 0/20 | 0/20 | 0/20 |
| Embodiment 9 | 0/20 | 0/20 | 0/20 | 0/20 | 0/20 | 0/20 |
| Embodiment 10 | 0/20 | 0/20 | 0/20 | 0/20 | 0/20 | 0/20 |
| Embodiment 11 | 0/20 | 0/20 | 0/20 | 0/20 | 0/20 | 0/20 |
| Embodiment 12 | 0/20 | 0/20 | 0/20 | 0/20 | 0/20 | 0/20 |
| Embodiment 13 | 0/20 | 0/20 | 0/20 | 0/20 | 0/20 | 0/20 |
| Embodiment 14 | 0/20 | 0/20 | 0/20 | 0/20 | 0/20 | 0/20 |
| Embodiment 15 | 0/20 | 0/20 | 0/20 | 0/20 | 0/20 | 0/20 |
| Reference Example 1 | 2/20 | 10/20 | 14/20 | 2/20 | 10/20 | 20/20 |
| Reference Example 2 | 5/20 | 16/20 | 18/20 | 8/20 | 14/20 | 20/20 |
| Reference Example 3 | 1/20 | 10/20 | 14/20 | 9/20 | 15/20 | 20/20 |

[Table 4]
Low Temperature Test: Airtight measurement result of the sealing member at test temperature of −40° C.

Note in the table that the denominator is the number of samples and the numerator is the number of samples to have had airtight trouble.

| | 1000 hrs | 3000 hrs | 5000 hrs |
|---|---|---|---|
| Embodiment 1 | 0/20 | 0/20 | 0/20 |
| Embodiment 2 | 0/20 | 0/20 | 0/20 |
| Embodiment 3 | 0/20 | 0/20 | 0/20 |
| Embodiment 4 | 0/20 | 0/20 | 0/20 |
| Embodiment 5 | 0/20 | 0/20 | 0/20 |
| Embodiment 6 | 0/20 | 0/20 | 0/20 |
| Embodiment 7 | 0/20 | 0/20 | 0/20 |
| Embodiment 8 | 0/20 | 0/20 | 0/20 |
| Embodiment 9 | 0/20 | 0/20 | 0/20 |
| Embodiment 10 | 0/20 | 0/20 | 0/20 |
| Embodiment 11 | 0/20 | 0/20 | 0/20 |
| Embodiment 12 | 0/20 | 0/20 | 0/20 |
| Embodiment 13 | 0/20 | 0/20 | 0/20 |
| Embodiment 14 | 0/20 | 0/20 | 0/20 |
| Embodiment 15 | 0/20 | 0/20 | 0/20 |
| Reference Example 1 | 10/20 | 14/20 | 20/20 |
| Reference Example 2 | 13/20 | 15/20 | 20/20 |
| Reference Example 3 | 15/20 | 20/20 | 20/20 |

As understood from the above Table 3 and Table 4, the construction of the sealing member of an aluminum electrolytic capacitor with the composition of ethylene-propylene-diene three way copolymeric rubber (EPDN containing 30-70 wt % of ethylene with glass transition temperature in the range between −70° C. and −30° C. is able to maintain elasticity at both high temperature and low temperature and also to prevent any airtight trouble from occurring

On the contrary thereto, in case of the aluminum electrolytic capacitor of the Reference Example 1, the use of the sealing member with the glass transition temperature of −48° C. is incapable of maintaining elasticity in high temperature and low temperature and thus causing an airtight problem in the sealing member.

As described hereinabove, the present invention not only restricts the glass transition temperature of the sealing member to the range between −70 and −30° C. but also chooses the ethylene content to the range of 30-70 wt % in the ethylene-propylene-diene three way copolymer rubber (EPDM) as a primary component. Accordingly, the sealing member maintains elasticity at a high temperature and a low temperature, thereby maintaining airtight performance.

Although the Present invention has been described on the aluminum electrolytic capacitor, it is to be noted that similar advantages to the present invention can be achieved in any electronic component for sealing a metal case with a sealing member, for example, an electrical double layer capacitor.

1. An aluminum electrolytic capacitor comprising a bottomed cylindrical metal case for accommodating a capacitor element having driving electrolyte impregnated therein and an elastic sealing member for sealing the open portion of the metal case, wherein the sealing member is made from as a primary composition ethylene-propylene-diene three way copolymer rubber (EPDM) containing 30-70 wt % of ethylene and the glass transition temperature of the sealing member is in the range between −70° C. and −30° C.

2. An aluminum electrolytic capacitor of claim 1, wherein the diene in the ethylene-propylene-diene three way copolymer rubber (EPDM) comprises at least one of 5-ethylidene-2-norbornene (ENB), di-cyclopentadiene (DCPD) and 1,4-hexadiene (HD) and the amount thereof is 3-6 wt %.

3. An aluminum electrolytic capacitor of claim 1, wherein the ethylene-propylene-diene three way copolymer rubber (EPDM) is bridged with peroxide.

4. An aluminum electrolytic capacitor of claim 1, wherein at least one material selected from the group of ethylene glycol, γ-butyrolactone, propylene carbonate, sulfolane and water is used as the driving electrolyte, and further containing one or more electrolytic salt selected from organic acid, or ammonium salt of organic acid or inorganic acid, or primary-quaternary ammonium salt, imidazolium salt, imidazolinium and any salt of the derivatives thereof.

5. An aluminum electrolytic capacitor of claim 2, wherein the ethylene-propylene-diene three way copolymer rubber (EPDM) is bridged with peroxide.
